(19) United States
(12) Patent Application Publication
(10) Pub. No.: US 2007/0102633 A1
(43) Pub. Date: May 10, 2007

(54) Mass spectrometer having an embedded web server

(76) Inventors: Karl Knute Kresie, Palo Alto, CA (US); Gregor T. Overney, San Jose, CA (US); David W. Peterson, Fremont, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/271,108

(22) Filed: Nov. 10, 2005

(51) Int. Cl. H01J 49/10

(52) U.S. Cl. 250/288; 250/282; 250/281

(57) ABSTRACT

A mass spectrometer includes an embedded web server that serves one or more web pages to a client computer in data communication with the mass spectrometer via a network. A user may access the one or more web pages via a web browser, and may thereby read data from, and/or control various functions of, the mass spectrometer.

### BACKGROUND

Mass spectrometry is a process by which a substance to be analyzed is first ionized, and then accelerated through a mass filter, en route to a detector. The mass filter generates an electromagnetic field that exerts force upon the ionized substance, as it travels therethrough. The mass filter is controlled to alter its electromagnetic field as a function of time. Accordingly, at a given point in time, only particles exhibiting a particular mass-to-charge ratio are able to traverse the mass filter and strike the detector located at the distal end thereof. Therefore, the mass spectrometer functions so as to generate a record of the relative abundance of ions exhibiting particular mass-to-charge ratios.

Various operational variables of a given mass spectrometer may be controlled by a user interface. For example, a mass spectrometer may use various ionization schemes, such as electron impact ionization, and chemical ionization, to name a few. In the context of chemical ionization, the substance to be analyzed is exposed to a large excess of ionized reagent gas, such as ammonia, for example. The substance to be analyzed interacts with the ionized reagent gas, and is thereby ionized, and propelled to the mass filter. Therefore, for example, one may wish to select the flow rate of the particular reagent gas. The aforementioned user interface provides a mechanism for exerting this kind of control (and other control, as well). Typically, the user interface is provided by a local computer that is distinct from the mass spectrometer, and networked thereto. The computer runs proprietary software that is specially designed to control the mass spectrometer.

The aforementioned control scheme exhibits certain opportunities for enhancement. For example, as the state of affairs presently stands, the aforementioned physically distinct computer must be executing a proprietary unit of software corresponding to a particular version of firmware running on a given mass spectrometer, in order to interact with that mass spectrometer. Thus, a firmware advancement in a given mass spectrometer may necessitate updating of the proprietary control software running on each computer intended to interact with the mass spectrometer—a time-consuming and odious requirement. It is therefore desirable to permit a computer to interface with a mass spectrometer without resort to execution of proprietary mass spectrometer control software executing outside the instrument.

### SUMMARY

In general terms, this document is directed to a mass spectrometer that includes an embedded web server, so that a user of a remote computer can interact with the mass spectrometer via a web browser, or any other HTTP client.

According to one embodiment, an apparatus includes a mass spectrometer and a first controller configured to be in communication with the mass spectrometer. The first controller includes a memory and a network interface. The mass spectrometer also includes a set of instructions stored in the memory. The set of instructions are configured to be responsive to non-proprietary application protocol requests.

According to another embodiment, a method of operating a mass spectrometer includes receiving a hypertext transfer protocol (HTTP) request from the web browser. The HTTP request is examined to determine an appropriate function to call in response thereto. The function contains instructions to control the mass spectrometer.

According to yet another embodiment, a mass spectrometer includes a first controller configured to be in communication with the mass spectrometer. The first controller includes a memory and a network interface. A set of instructions is stored in the memory. The instructions are configured to provide an HTTP server.

### BRIEF DESCRIPTION OF THE DRAWINGS

FIG. 1 depicts an example of an embodiment of a mass spectrometer.

FIG. 2 depicts an example of an embodiment of a software/firmware system executed by a mass spectrometer.

FIG. 3 depicts an example of a home page served by a web server embedded in the mass spectrometer.

FIG. 4 depicts an example of a real-time clock web page served by a web server embedded in the mass spectrometer. FIG. 5 depicts another example of a real-time clock web page served by a web server embedded in the mass spectrometer.

FIG. 6 depicts an example of a command/query web page served by a web server embedded in the mass spectrometer.

FIG. 7 depicts an example of a buffer trace web page served by a web server embedded in the mass spectrometer.

FIG. 8 depicts an example of an instrument status web page served by a web server embedded in the mass spectrometer.

FIG. 9 depicts an example of an instrument control web page served by a web server embedded in the mass spectrometer.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

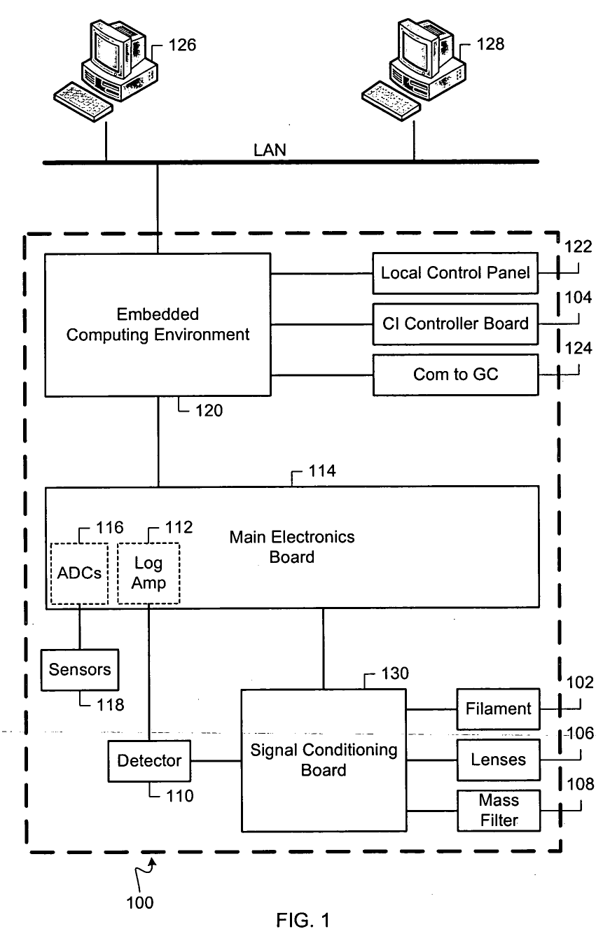

FIG. 1 depicts an example embodiment of a mass spectrometer 100 for the general orientation of the reader. It is understood that other architectures exist and are possible, and such architectures are contemplated herein. During operation, the substance to be analyzed enters the mass spectrometer 100, and is initially ionized. For example, in the context of an embodiment using electron impact ionization, the substance is ionized by interaction with an electron beam generated by a filament 102. Alternatively, in the context of an embodiment using chemical ionization, the substance is ionized by interaction with an ionized reagent gas delivered under the control of a chemical ionization controller board 104. (For the sake of illustration only, the mass spectrometer 100 is described herein as utilizing a chemical ionization scheme, although such a state of affairs is not required for practice of the invention.) Regardless of how the substance is ionized, it is directed by a set of lenses 106 through a mass filter 108. Ions exhibiting a particular mass-to-charge ratio successfully traverse the mass filter 108, and strike a detector 110. In response, the detector 110 returns a relative abundance signal to a logarithmic amplifier 112, which may be embodied within a main electronics board 114. The main electronics board 114 contains, for example, a logic system, such as a field programmable gate array (FPGA), in communication with the logarithmic amplifier 112. The electronics board 114 also contains interface circuitry as necessary (filters, level shifters, etc.) to permit the logic system to interact with the logarithmic amplifier 112, and with sensors 118 (via an analog-to-digital converter 116) that detect various operational conditions of the mass spectrometer (e.g., temperature of the ion source and mass filter, etc.).

The main electronics board 114 interfaces with an embedded computing environment 120. According to some embodiments, the embedded computing environment 120 includes a processor, a digital signal (DSP) processor, a memory unit(s), a network interface for communication with a local area network (LAN), and interfaces, such as an input/output (I/O) interface, for interaction with a local control panel 122 and/or for interaction with a communication interface 124 for a gas chromatograph.

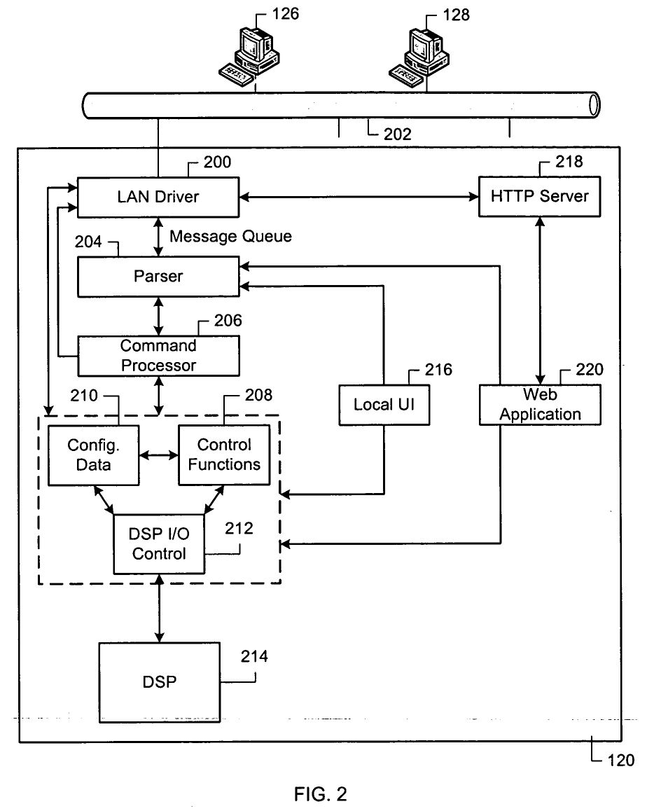

An operator may control the mass spectrometer 100 via the local control panel 122, or via a computer 126 and/or 128 networked to the mass spectrometer 100 by a LAN. Instructions from any of these sources are received by the embedded computing environment 120, and communicated to the main electronics board 114 for subsequent execution. In response, the main electronics board 114, may, for example, send one or more signals to the signal conditioning board 130 for conversion into one or more proper control signal for the element to be controlled. For example, the detector 110 creates an abundance signal that is approximately equal to the ion impact rate multiplied by a gain factor. The gain factor may be set by application of an appropriate control signal to the detector 110. The signal conditioning board 130 receives signals from the main electronics board 114, and generates an appropriate control signal to cause the detector 110 to employ the desired gain factor. FIG. 2 depicts an example of a software/firmware system executing on the embedded computing environment 120 (FIG. 1). The system includes a LAN driver 200. The LAN driver 200 provides an interface between the various software/firmware components depicted in FIG. 2 and a LAN 202. A computer, such as computer 126 or 128, may be in data communication with the various software/firmware components via the LAN 202.

The computers 126 and 128 may execute a specialized software package through which they communicate with the mass spectrometer via a unique command language, referred to herein as a “spectrometer command language.” When running the specialized software package, the communication scheme employed by the computers 126 and 128 is connection-oriented, and as a result, only one of the computers 126 and 128 may interact with the mass spectrometer at a given time. (The spectrometer command language is discussed further below. The computers 126 and 128 may also execute a web browser application, as is also discussed below.) Per such an embodiment, a command is communicated from a computer 126 or 128, through the LAN 202, and is received by the LAN driver 200. The LAN driver 200 recognizes the incoming packet as containing a spectrometer command language command, and forwards the command to a parser 204.

The parser 204 breaks the command into its constituent function and argument components, and, on the basis of those components, invokes a function in the command processor 206. In response, the invoked function within the command processor 206 calls a sequence of mass spectrometer control functions 208, which generally cooperate to cause the commanded action to be undertaken, for example, by altering mass spectrometer configuration data 210, and/or by communicating with a DSP I/O control module 212, which, in turn, communicates with a DSP processor 214, also included within the embedded computing environment 120. The DSP processor 214 is used for interaction requiring operations executed in a fashion more rapidly than can be supported by a normal processor, such as the processor executing the parser 204, command processor 206, etc. Thus, for example, the mass filter 108 may be interacted with via the DSP I/O control module 212 in order to obtain spectral data therefrom.

Another manner in which the mass spectrometer may be operated is by entry of a command via the local control panel 122 (FIG. 1), whereupon the command is serviced by the local user interface module 216, and delivered either to the parser 204 for handling in the aforementioned described manner, or a control function 208 is directly invoked.

The software/firmware system of FIG. 2 also includes a hypertext transfer protocol (HTTP) server 218. The HTTP server 218 interacts with the LAN driver 200, and receives HTTP commands therefrom, and services those commands. Accordingly, the computers 126 and 128 are able to communicate with the mass spectrometer via any software package that supports HTTP functionality (e.g., a web browser, etc.). Because HTTP is a stateless protocol, and because the web application 220 and the control functions 208 are designed to support multiple clients, both computers 126 and 128 may interact with the mass spectrometer concurrently. Additionally, the computers 126 and 128 may interact with the mass spectrometer via the web application, while another computer running the aforementioned proprietary software controls the mass spectrometer. Per such an arrangement, the computer 126 or 128 running the web browser may act as a diagnostic tool, while the computer running the proprietary software acts as the main control interface. Thus, for example, a user may access a networked computer 126 or 128, and may activate its web browser. The user may then enter the internet protocol (IP) address assigned to the network card (driven by the LAN driver 200) within the mass spectrometer. In response thereto, an HTTP command is carried in a packet across the LAN 202 to the LAN driver 200, which delivers the HTTP command to the HTTP server 218.

The HTTP server 218 services the command and returns web content (e.g., a web page, Java script code, HTML, cascading style sheets, etc.) to the client computer 126 or 128. The web content returned to the computer is referred to herein as a “web page” for ease of reference. The various web pages returned by the HTTP server 218 are constructed by a web application 220, which serves as an interface between the HTTP server 218 and the parser 204 or control functions 208. Thus, as discussed in more detail below, a user may interface with the mass spectrometer via a web browser, and may access the ordinary command functionality of the mass spectrometer by way of the cooperative efforts of the HTTP server 218 and the web application 220.

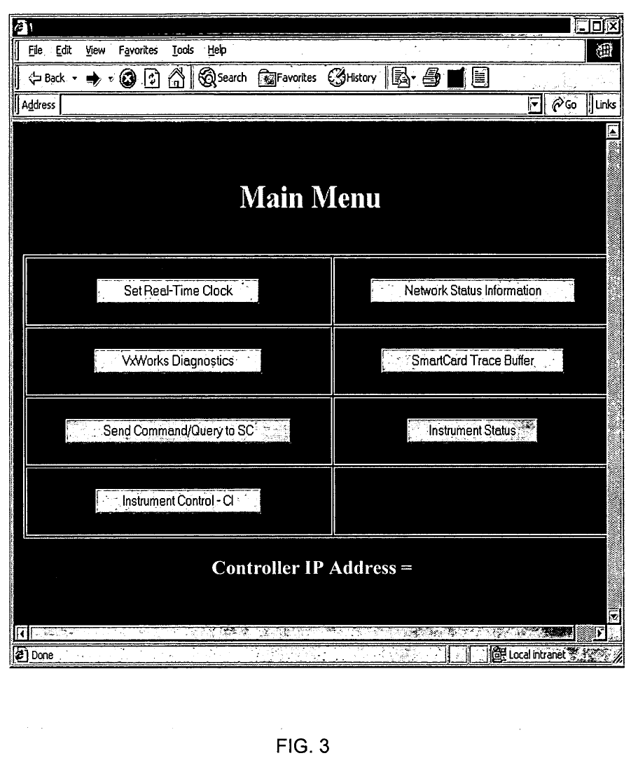

According to one embodiment, the HTTP server 218 returns the web page shown in FIG. 3, in response to a user at a computer 126 or 128 entering the IP address assigned to the mass spectrometer into the address bar of the web browser (i.e., the web page of FIG. 3 is the home page). As can be seen from FIG. 3, the home page presents a menu of functionality offered by the mass spectrometer, or a subset thereof. For example, the home page may offer links to access other pages that permit reading of a real-time clock of the web client (and setting of the real-time clock within the mass spectrometer), viewing of network status information, viewing of diagnostic information, viewing of a buffer of commands executed by the mass spectrometer, submission of a command or query to the mass spectrometer using the aforementioned spectrometer command language, viewing of instrument status, and setting of instrument control, such as control over the chemical ionization controller board 104 (FIG. 1). Of course, other functionality provided by the mass spectrometer may also be presented as an option on the home page. Also, according to some embodiments, the home page presents the IP address assigned to the mass spectrometer.

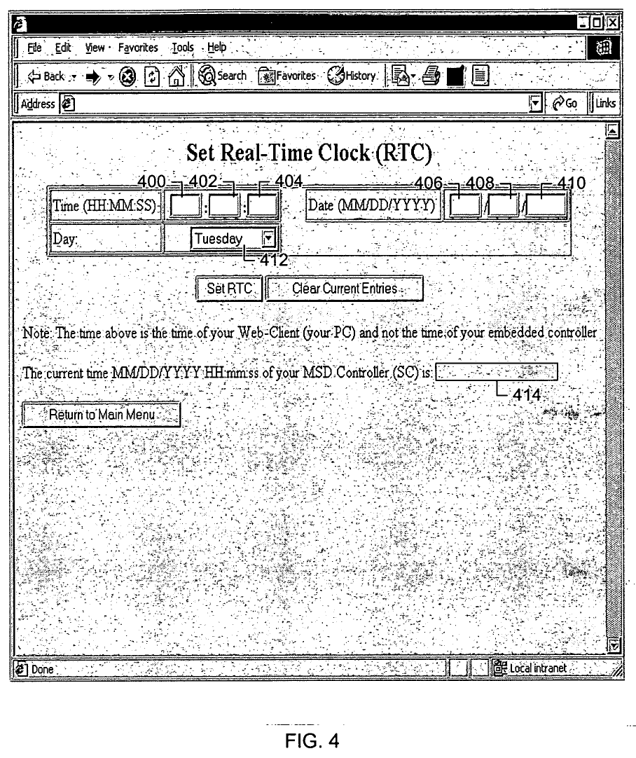

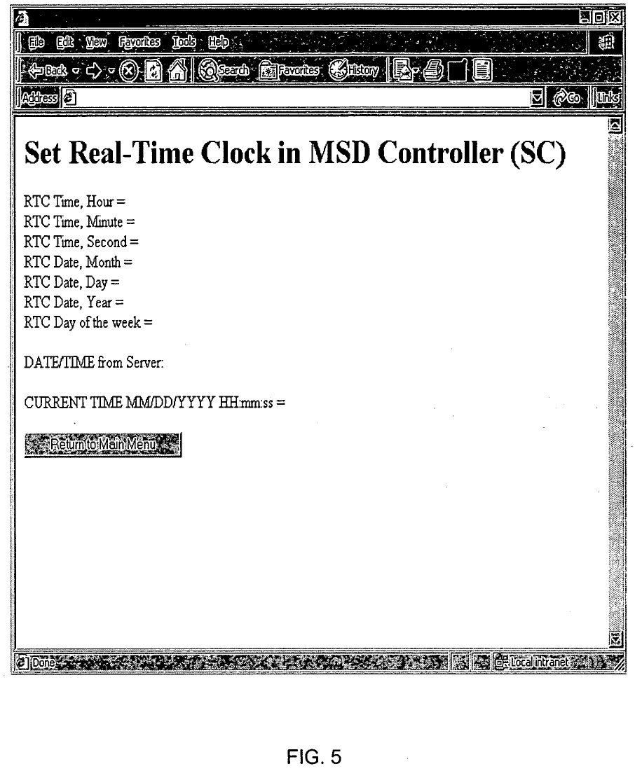

In response to selection of a link on the home page, the HTTP server 218 responds, with the aid of the web application 220, by returning a web page that provides access to the functionality identified by the selected link. For example, according to one embodiment, selection of the “Set Real-Time Clock” link results in presentation of the web page depicted in FIG. 4.

FIG. 4 depicts a web page that permits viewing of the real-time clock used by the web client (i.e., the computer 126 or 128). The web page includes fields for presentation of the hour 400, minute 402, and second 404 of the real-time clock. The web page also presents fields for presentation of the month 406, day 408, year 410, and day of week 412. Additionally, the web page presents a field 414 for returning the month/day/year and hour:minute:second data of a real-time-clock maintained by the embedded computing environment 120 (FIG. 1). (Such information is obtained by the web application 220, shown in FIG. 2). Thus, any discrepancy between the real-time clock maintained by the computer 126 or 128 at which the user is located and the real-time clock maintained by the mass spectrometer is evident from the web page of FIG. 4.

If no discrepancy exists, the user may select the “Return to Main Menu” link, and the web browser is again served with the home page presented in FIG. 3. On the other hand, if a discrepancy is present, the user may select the “Set RTC” link, causing a command to be sent to the mass spectrometer to set its real-time clock to the values presented in fields 400-412. The values in fields 400-412 are user-modifiable, so that the real-time clock maintained by the mass spectrometer may be set to any desired value, as opposed to only providing the capacity to set the real time clock to that of the web client. As described above, such a command is received by the HTTP server 218, transferred to the web application 220, and sent to either the parser 200 or directly to a control function 208 (in this case, the command is sent directly to a control function 208 that alters data 210 describing the time and data of the real-time clock maintained by the embedded computing environment 120). The real-time clock maintained by the embedded computing environment 120 is thereby altered to be consistent with that specified by the user, and the HTTP server 218 responds by delivering the web page shown in FIG. 5 to the computer 126 or 128. As can be seen from FIG. 5, the web page presents both the date/time of the clock specified by the user, and the date/time of the clock (as now altered) maintained by the embedded computing environment 120. As described above, the user may select the “Return to Main Menu” link, and the web browser is again served with the home page presented in FIG. 3.

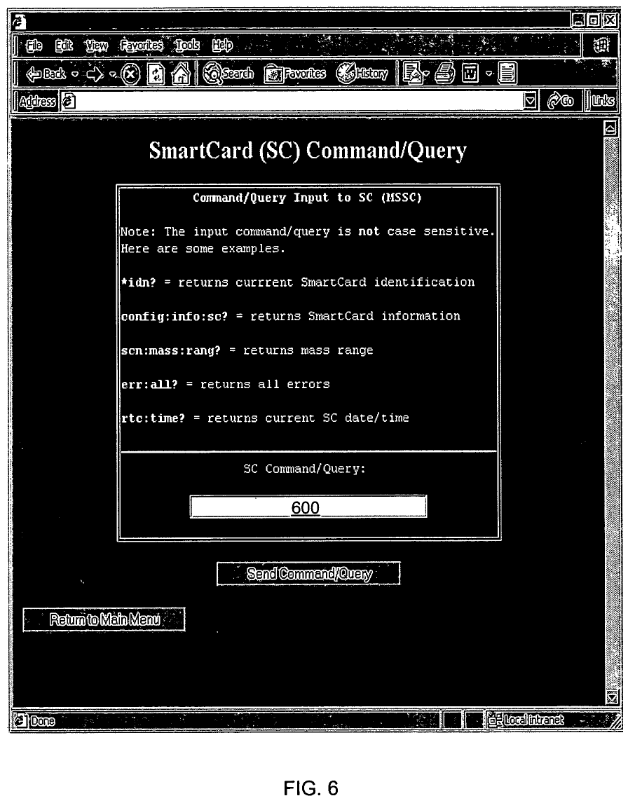

From the home page depicted in FIG. 3, the user may select the “Send Command/Query to SC” link. Such an action results in presentation of the web page depicted in FIG. 6. The web page of FIG. 6 include a field 600 into which a spectrometer command language command (referred to as an “SC Command/Query” in the particular web page depicted in FIG. 6) may be entered. Thus, for example, a user may enter the text string “rtc:time?” into the field 600, and may select the “Send Command/Query” link. Selection of the aforementioned link causes the spectrometer command language command to be sent to the spectrometer, whereupon it is received by the LAN driver 200 (FIG. 2), which operates upon the command as though it had been entered at a computer executing the aforementioned specialized software for entry of such commands. In other words, the command is transferred to the command to the parser 204. As explained previously, the command is parsed into its constituent function (in the context of the above-described example, “rtc”) and argument (e.g., “time?”). Thereafter, a function in the command processor 206 is invoked with the argument “time,” the appropriate control functions are called (if necessary), and the time maintained by the real-time clock of the embedded computing environment 120 is returned to the web application 220, which builds a web page (not depicted herein) presenting that time. The web page is served to the client computer 126 or 128 by the HTTP server 218.

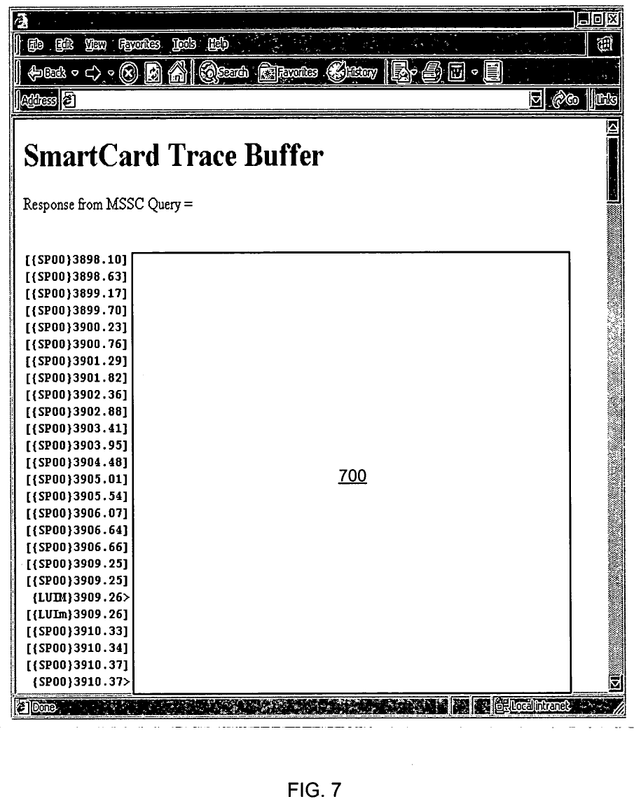

According to one embodiment, a buffer or message queue of the last N (e.g., 500) commands transferred to the parser 204 is maintained by the embedded computing environment 120. The buffer may also include responses to the commands. For example, if the command was a query to return the temperature measured at the ion source by a sensor 118 (FIG. 1), the result of the query may stored in the buffer, in association with the query. According to one embodiment, the buffer, may be accessed by selection of the “SmartCard Trace Buffer” link on the home page depicted in FIG. 3. Such an action results in presentation of the web page depicted in FIG. 7. The web page of FIG. 7 include an area 700. The area 700 is populated with a list of commands/queries, responses thereto, and diagnostic messages from the embedded computing environment 120 (e.g., error codes, indications of the occurrence of certain events or decisions, etc.). Such population occurs by virtue of the web application 220 accessing the buffer to retrieve the aforementioned commands, queries, and results, and constructing the web page of FIG. 7 to present the retrieved information.

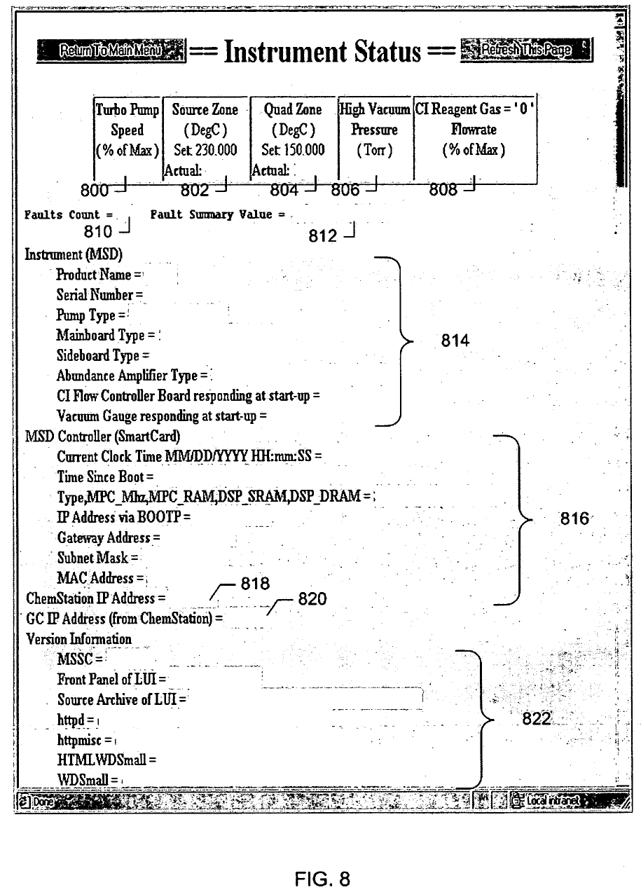

From the home page depicted in FIG. 3, the user may select the “Instrument Status” link. Such an action results in presentation of the web page depicted in FIG. 8. As can be seen from FIG. 8, the web page includes a variety of fields 800-822. The fields are populated by the web application 220, which constructs the web page of FIG. 8. The information presented on the web page of FIG. 8 allows for viewing of status information related to various configuration and operational parameters of the mass spectrometry system (and other systems cooperating therewith, if any). For example, the web page includes: a field 800 for presentation of the speed of the pump that creates the vacuum in the ionization chamber; a field 802 for presentation of the temperature of the ionization chamber; a field 804 for presentation of the temperature within the mass filter; a field 806 for presentation of the pressure within the vacuum chamber; a field 808 for presentation of the flow rate of the reagent gas; a field 810 for presentation of the quantity of faults detected by the mass spectrometer; a field 812 for presentation of information describing the faults; a set of fields 814 for presentation of information identifying the various components within the mass spectrometer; a set of fields 816 for presenting information concerning the embedded computing environment 120; a field 818 for presenting the IP address of a computer executing specialized software for interaction with the mass spectrometer; a field 820 for presenting the IP address of a gas chromatograph (if any) coupled to the mass spectrometer; and a set of fields 822 for presentation of version information concerning hardware/firmware/software within the mass spectrometer.

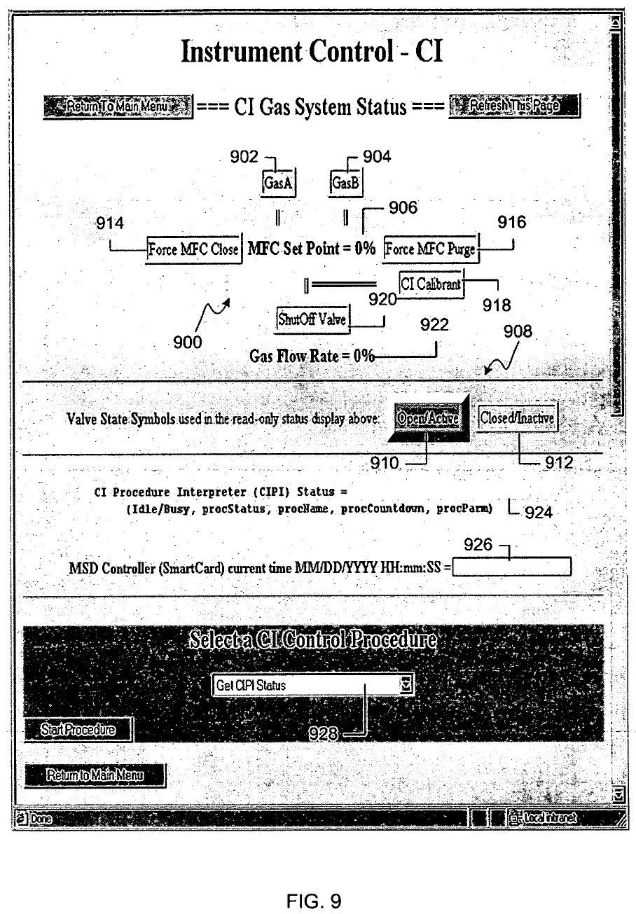

According to some embodiments, the mass spectrometer may utilize a chemical ionization scheme. Per these embodiments, the mass spectrometer includes a chemical ionization controller board 104 that interacts with the embedded computing environment. According to some embodiments, the chemical ionization controller board 104 exerts control over the flow of one or more (e.g., two) reagents into the ionization chamber of the mass spectrometer. Selection of the “Instrument Control-CI” link results in presentation of a web page that allows for commanding the chemical ionization board to perform common tasks. FIG. 9 depicts an example of such a web page.

The web page of FIG. 9 includes a schematic portion 900 that graphically depicts the activity of the chemical ionization controller board 104. The schematic portion includes icons representing a first and second chemical reagents 902 and 904. These reagents reside in their respective reservoirs, which are controlled by way of a set of valves. When appropriate valves are opened, the reagent exits the reservoir, and flows through a conduit to a mass flow controller, which controls the rate of flow of the reagent into the ionization chamber. The schematic portion 900 includes a field 906 that indicates the set point of the mass flow controller. The icons 902 and 904 may take on two different appearances, in order to indicate whether the corresponding valve is opened or closed. A key 908 explains the interpretation. As suggested by the key 908, an icon takes on the appearance of icon 910, when the valve corresponding thereto is open, or if the function corresponding thereto is active. On the other hand, an icon takes on the appearance of icon 912, when the valve corresponding thereto is closed, or if the function corresponding thereto is inactive. Thus, the icons 902 and 904 indicate that the valves permitting entry of both reagent gasses A or B into the ionization chamber are closed. Further, the schematic representation 900 includes an icon 914 representing the activity/inactivity of a function whereby the mass flow controller is forced closed (the icon 914 reveals that this function is inactive). Additionally, the schematic representation 900 includes an icon 916 representing the activity/inactivity of a function whereby the mass flow controller is forced entirely open (the icon 916 reveals that this function is inactive). Additionally, the schematic representation 900 includes an icon 918 representing a calibrant that may be aspirated into the gas flow. The icon 918 indicates that the calibrant is not entering the gas flow. Finally, the schematic representation includes an icon 920 representing a shut off valve interposed between the source of calibrant and the ionization chamber. The icon 920 reveals that the valve is closed.

According to some embodiments, the web page of FIG. 9 also includes an indication of the measured gas flow rate 922 (as opposed to the desired flow rate 906).

According to some embodiments, the web page also includes a status field 924 that indicates whether a process is being carried out by the chemical ionization board, the identity of the process, the status of the process, and information concerning how close the process is to being completed.

According to some embodiments, the web page also includes a menu 928 presenting common processes to be carried out by the chemical ionization controller board 104. For example, according to one embodiment, the menu includes choices for obtaining the aforementioned procedure status information, setting the flow rate of a first gas to a desired level (e.g., setting Gas A to a flow rate of 10%, 99%, or any other desired value), setting the flow rate of a second gas to a desired level (e.g., setting Gas B to a flow rate of 10%, 99%, or any other desired value), setting the flow rate of a first gas to a desired level for a desired period of time (e.g., setting Gas A to a flow rate of 10%, 99%, or any other desired value for 30 seconds, 60 minutes, or any other desired value), setting the flow rate of a second gas to a desired level for a desired period of time (e.g., setting Gas B to a flow rate of 10%, 99%, or any other desired value for 30 seconds, 60 minutes, or any other desired value), and pumping out the ionization chamber with the aforementioned valves controlling the supply of reagent gasses turned off for a selected period (e.g., for 6 minutes, 60 minutes, or any other desired value of time). The user may make a selection from the menu 928, and select the “Start Procedure” button 930. In response thereto, the selected option within the menu 928 is returned to HTTP server 218 (by way of the LAN driver 200), whereupon it is passed to the application layer 220. The application layer responds by directly invoking the control function 208 with the appropriate argument, and the selected procedure is executed by the mass spectrometer.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. An apparatus comprising:
a mass spectrometer including a chemical ionization system that includes a plurality of valves configured to control flow of a reagent gas to an ionization system;
a first controller configured to be in communication with the mass spectrometer, the first controller including a memory and a network interface;
a set of instructions stored in the memory, the instructions responsive to non-proprietary application protocol requests to permit control of the chemical ionization system.

2. The mass spectrometer of claim 1, wherein the memory is further configured to store a set of instructions, which when executed, cause the controller to respond to a non-proprietary application protocol request by controlling the chemical ionisation system to purge a conduit coupled thereto for a given span of time.

3. The mass spectrometer of claim 1, wherein the memory is further configured to store a set of instructions, which when executed, cause the controller to respond to an non-proprietary application protocol request by activating a pump for a given span of time, while at least one of the plurality of valves is closed, so as to evacuate gas supply lines of the mass spectrometer.

4. The mass spectrometer of claim 1, wherein the memory is further configured to store a set of instructions, which when executed, cause the controller to respond to a non-proprietary application protocol request by returning instrument status information.

5. The mass spectrometer of claim 4, wherein instrument status information comprises temperature information concerning temperature of the ion source or mass filter.

6. The mass spectrometer of claim 4, wherein instrument status information comprises pressure within a vacuum chamber included in the mass spectrometer.

7. The mass spectrometer of claim 4, wherein instrument status information comprises flow rate of a reagent gas to the ion source.

8. The mass spectrometer of claim 4, wherein instrument status information comprises an operating speed of a pump maintaining a vacuum within a vacuum chamber included in the mass spectrometer.

9. The mass spectrometer of claim 4, wherein instrument status information comprises version information of firmware executed by the mass spectrometer.

10. The mass spectrometer of claim 1, wherein the non-proprietary application protocol comprises hypertext transfer protocol (HTTP).

11. The mass spectrometer of claim 10, wherein the instructions are configured to control the mass spectrometer in response to an HTTP request.

12. A method of operating a mass spectrometer, the method comprising:
receiving a hypertext transfer protocol (HTTP) request from a web browser; and
examining the HTTP request to determine an appropriate function to call in response thereto, the function containing instructions to control a chemical ionization system of the mass spectrometer.

13. The method of claim 12, wherein examining the HTTP request comprises determining whether the HTTP request contains a command string that should be passed to a parser.

14. The method of claim 13, further comprising parsing the command string into tokens, and determining the appropriate function to call, based upon the tokens.

15. A mass spectrometer comprising:
a mass spectrometer;
a first controller configured to be in communication with the mass spectrometer, the first controller including a memory and a network interface; and
a set of instructions stored in the memory, the instructions configured to provide an HTTP server that provides a web page presenting status information concerning the mass spectrometer.

16. The mass spectrometer of claim 15, wherein the memory is further configured to store a set of instructions, which when executed, cause the controller to examine a packet received via a network, in order to determine whether the packet contains an HTTP request or another form of request.

17. The mass spectrometer of claim 16, wherein the memory is further configured to store a set of instructions, which when executed, cause the controller to permit the mass spectrometer to be commanded or monitored in response to the other form of request data.

18. The mass spectrometer of claim 15, wherein instrument status information comprises pressure within a vacuum chamber included in the mass spectrometer.

19. The mass spectrometer of claim 15, wherein instrument status information comprises flow rate of a reagent gas to the ion source.

20. The mass spectrometer of claim 15, wherein instrument status information comprises an operating speed of a pump maintaining a vacuum within a vacuum chamber included in the mass spectrometer.
